(19) United States
(12) Patent Application Publication
(10) Pub. No.: US 2016/0252042 A1
(43) Pub. Date: Sep. 1, 2016

(54) Cylinder Liner

(71) Applicant: AVL Powertrain Engineering, Inc., Plymouth, MI (US)

(72) Inventors: Iain Read, Warren, MI (US); Julian SHERBORNE, Novi, MI (US)

(21) Appl. No.: 15/050,549

(22) Filed: Feb. 23, 2016

Related U.S. Application Data
(60) Provisional application No. 62/121,741, filed on Feb. 27, 2015.

(51) Int. Cl. F02F 1/00

(52) U.S. Cl. CPC F02F 1/004

(57) ABSTRACT

A cylinder liner with improved cooling and strength is disclosed. The cylinder liner includes a liner wall extending annularly about a piston bore. The liner wall has an inner face adjacent the piston bore and an outer face oppositely arranged relative to the inner face. The outer face includes a water jacket surface that is co-extensive with at least part of the outer face. A plurality of indentations are disposed along the water jacket surface of the liner wall. The plurality of indentations extend radially inwardly from the water jacket surface to define corresponding areas in the liner wall of compacted material. Accordingly, the plurality of indentations increase surface area of the water jacket surface to improve heat transfer away from the liner wall while also increasing hoop strength of the liner wall.

### CROSS-REFERENCE TO RELATED APPLICATIONS

This application claims the benefit of U.S. Provisional Application No. 62/121,741, filed on Feb. 27, 2015. The entire disclosure of the application referenced above is incorporated herein by reference.

### FIELD

The present disclosure generally relates to the field of internal combustion engines. More specifically, a cylinder liner for insertion into a cylinder bore of an engine block is disclosed along with a method for manufacturing the disclosed cylinder liner.

### BACKGROUND

This section provides background information related to the present disclosure which is not necessarily prior art.

Many internal combustion engines utilize cylinder liners or sleeves. Such internal combustion engines generally include an engine block having one or more cylinder bores. A piston is disposed within each cylinder bore when the internal combustion engine is fully assembled. Cylinder liners, which are generally cylindrical in shape, are positioned within the cylinder bore of the internal combustion engine between the piston and the engine block. Accordingly, the piston does not directly contact the engine block. Although cylinder liners often add complexity to the engine block, cylinder liners have many advantages. The cylinder liner presents a wear surface that can be replaced in the event of excessive wear. Excessive wear may occur in internal combustion engines that experience piston or ring failure. In such instances, the internal combustion engine can be more easily repaired without the need for re-boring and honing the engine block or replacing the engine block altogether. Cylinder liners can also be made from a different material than the material used in the engine block. Accordingly, the engine block can be made of a lighter, more brittle material such as aluminum to save weight, while the cylinder liner can be made of a heavier, stronger material such as cast iron or steel to improve thermodynamics and durability.

One design problem that arises in internal combustion engines that utilize cylinder liners is how to effectively draw heat away from the cylinder liners. Cylinder liners are exposed to combustion and therefore are subject to high thermal loads. The cylinder liners themselves are relatively thin and often conduct heat better than the adjacent material of the engine block, making thermal management of the cylinder liner difficult. One solution to this problem is commonly referred to as a “wet liner” arrangement. In this arrangement, at least part of the cylinder liner is placed in direct contact with coolant water. The coolant water flows through a water jacket passageway disposed between at least a portion of the cylinder liner and the engine block. Thermal management is achieved more readily because heat from the cylinder liner is transferred directly to the coolant water. The coolant water in the water jacket passageway is replenished so that heat is continuously being drawn from the cylinder liner.

To increase heat transfer between the cylinder liner and the coolant water, several known designs call for cylinder liners with cut or cast-in grooves. While these designs do increase the surface area of the cylinder liner for improved cooling, the cut or cast-in grooves decrease the overall strength of the cylinder liner for any given liner wall thickness. Where the cylinder liner features cut grooves, the cutting operation removes material from the liner wall thereby weakening the cylinder liner. Where the cylinder liner features cast-in grooves, there is an absence of material adjacent the grooves (i.e. thinned areas in the liner wall). Accordingly, the cylinder liner is weak adjacent the grooves. Such cylinder liners sacrifice strength for cooling gains. As a result, these cylinder liners are more prone to deformation and failure during installation and operation of the internal combustion engine. Also, the compression ratio and maximum allowed engine speed (i.e. red-line rpms) of the internal combustion engine may have to be limited due to the reduced strength of the cylinder liner.

### SUMMARY

This section provides a general summary of the disclosure and is not a comprehensive disclosure of its full scope or all of its features.

The subject disclosure provides for a cylinder liner with improved cooling and strength. The cylinder liner includes a liner wall that extends annularly about a piston bore. The liner wall has an inner face adjacent the piston bore and an outer face that is oppositely arranged with respect to the inner face. The outer face of the liner wall includes a water jacket surface that is co-extensive with at least part of the outer face. A plurality of indentations are disposed along the water jacket surface of the outer face of the liner wall. The plurality of indentations extend radially inwardly from the water jacket surface to define corresponding areas in the liner wall of compacted material. Accordingly, the plurality of indentations increase surface area of the water jacket surface to improve heat transfer away from the liner wall while also increasing hoop strength of the liner wall.

In accordance with another aspect of the subject disclosure, the plurality of indentations are formed by a deformation process where no material is removed from the liner wall adjacent the water jacket surface. Additionally, the plurality of indentations may generally be arranged in a pattern that spans an axial length of the water jacket surface. By increasing the surface area of the water jacket surface, the plurality of indentations help to increase heat transfer between the cylinder liner and coolant water. However, unlike in other designs where cut or cast-in grooves decrease the overall strength of the cylinder liner for a given liner wall thickness, the plurality of indentations do not weaken the liner wall. Since no material is removed to create the plurality of indentations, weak points are not formed in the liner wall. In fact, the hoop strength of the cylinder liner may actually be improved by the application of the plurality of indentations because areas of compacted material are created in the liner wall adjacent each indentation and this compacted material adds strength. Accordingly, cooling gains may be realized by the plurality of indentations without sacrificing the strength of the cylinder liner. The resulting cylinder liner is thus less prone to deformation and failure. Also, the compression ratio and maximum allowed engine speed of the internal combustion engine may be increased for improved power and efficiency.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a front perspective view of an exemplary internal combustion engine;

FIG. 2 is a partial cross-sectional view of an exemplary engine block with an exemplary sleeve installed in the cylinder bore;

FIG. 3 is a partial cross-sectional view of another exemplary engine block with another exemplary sleeve installed in the cylinder bore;

FIG. 4 is a partial cross-sectional view of another exemplary engine block with another exemplary sleeve installed in the cylinder bore;

FIG. 5 is a front perspective view of an exemplary cylinder liner constructed in accordance with the subject disclosure;

FIG. 6 is a front perspective view of another exemplary cylinder liner constructed in accordance with the subject disclosure;

FIG. 7 is a partial front view showing an exemplary arrangement of indentations in the water jacket surface of an exemplary cylinder liner constructed in accordance with the subject disclosure;

FIG. 8 is a partial front view showing another exemplary arrangement of indentations in the water jacket surface of an exemplary cylinder liner constructed in accordance with the subject disclosure;

FIG. 9 is a partial front view showing another exemplary arrangement of indentations in the water jacket surface of an exemplary cylinder liner constructed in accordance with the subject disclosure;

FIG. 10 is a partial front view showing another exemplary arrangement of indentations in the water jacket surface of an exemplary cylinder liner constructed in accordance with the subject disclosure;

FIG. 11 is a partial front view showing another exemplary arrangement of indentations in the water jacket surface of an exemplary cylinder liner constructed in accordance with the subject disclosure;

FIG. 12 is a partial front view showing another exemplary arrangement of indentations in the water jacket surface of an exemplary cylinder liner constructed in accordance with the subject disclosure; and

FIG. 13 is a schematic diagram illustrating the steps of an exemplary method for manufacturing a cylinder liner in accordance with the subject disclosure.

### DETAILED DESCRIPTION

Referring to the Figures, wherein like numerals indicate corresponding parts throughout the several views, a cylinder liner 20 is disclosed.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

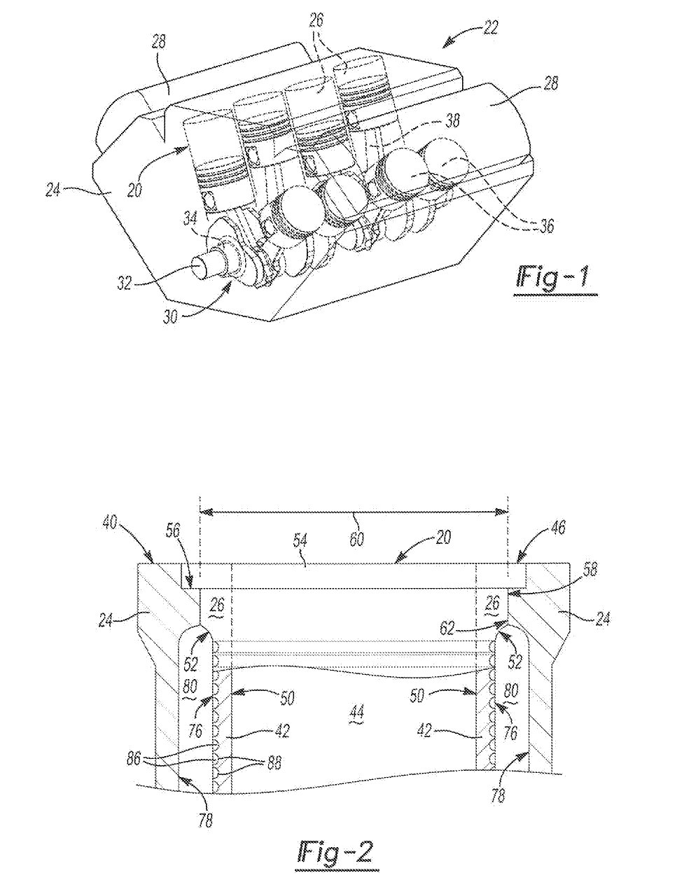

It should initially be understood that the cylinder liner 20 disclosed herein exists as one of many component parts of an internal combustion engine 22. In general, the cylinder liner 20 may be utilized for each cylinder of the internal combustion engine 22. The internal combustion engine 22 could be, without limitation, a spark ignition engine (e.g. a gasoline fueled engine) or a compression ignition engine (e.g. a diesel fueled engine). One exemplary internal combustion engine 22 is illustrated in FIG. 1. With reference to FIG. 1, the internal combustion engine 22 generally includes an engine block 24 with one or more cylinder bores 26. Cylinder heads 28 mate with the engine block 24 and close off the cylinder bores 26 of the engine block 24. Opposite the cylinder heads 28, the cylinder bores 26 are open to a crankcase 30 defined by the engine block 24. The internal combustion engine 22 includes a crankshaft 32 that is disposed within the crankcase 30. The crankshaft 32 is carried on bearings 34 such that the crankshaft 32 may rotate freely within the crankcase 30. A piston 36 is situated in each cylinder bore 26 of the engine block 24. Combustion occurs in the cylinder bore 26 between the cylinder head 28 and the piston 36. A connecting rod 38 extends between and connects each piston 36 to the crankshaft 32. The combustion process drives each piston 36 in a reciprocating motion within the cylinder bore 26 and the connecting rods 38 translate the reciprocating motion of the piston 36 into rotational motion of the crankshaft 32.

Referring to FIGS. 2-4, a partial cross-sectional view of the engine block 24 is illustrated. From these views, it can be seen that the cylinder liner 20 is disposed in the cylinder bore 26 of the engine block 24 such that the cylinder liner 20 is positioned radially between the piston 36 and the engine block 24. Accordingly, the piston 36 contacts the cylinder liner 20 rather than the engine block 24 itself. The cylinder liner 20 is positioned axially within cylinder bore 26 so that it sits below a deck surface 40 of the engine block 24. It should be appreciated that the cylinder heads 28 abut the deck surface 40 of the engine block 24 when the cylinder heads 28 are installed on the engine block 24. The cylinder liner 20 may be a stand-alone component that is separately made from the engine block 24 or the cylinder liner 20 may be integral with the engine block 24. Both configurations fall within the scope of the subject disclosure. Where the cylinder liner 20 is separately made, the cylinder liner 20 is inserted and/or pressed into the cylinder bore 26 of the engine block 24 during assembly of the internal combustion engine 22.

The cylinder liner 20 may or may not be made from the same material as the engine block 24. Advantageously, where the cylinder liner 20 is made from a different material than that used for the engine block 24, the cylinder liner 20 may be made to have improved strength, improved wear resistance, better thermal characteristics, and reduced friction. Internal combustion engines having cylinder liners may also be more easily serviced because a damaged cylinder liner can simply be replaced, thereby reducing or eliminating the need for labor intensive boring and honing of the engine block.

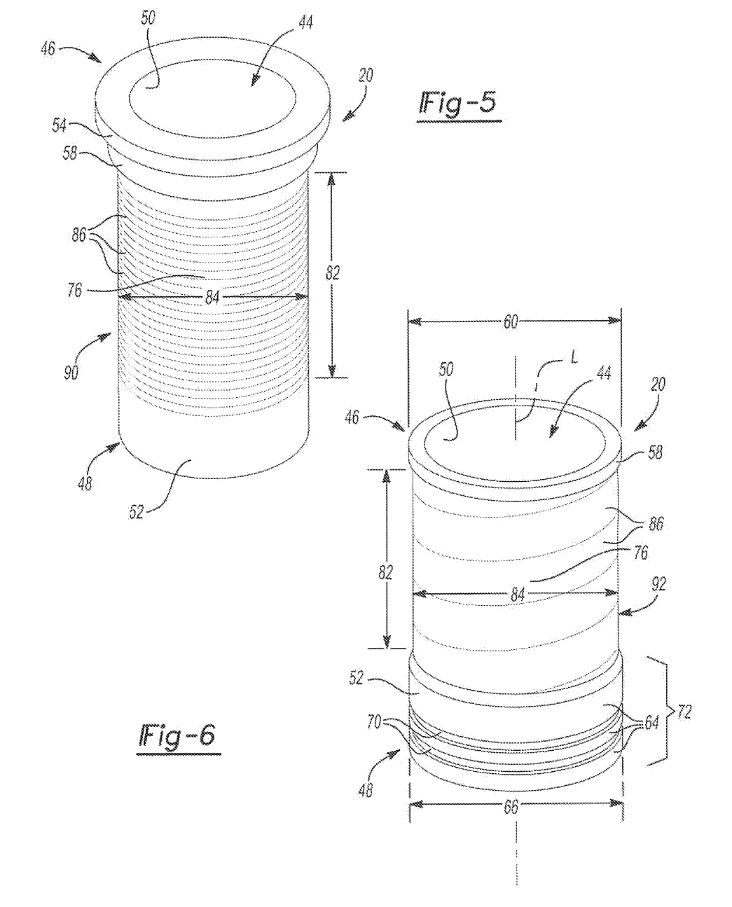

FIGS. 5 and 6 depict two exemplary variations of the disclosed cylinder liner 20 before insertion into the cylinder bore 26 of the engine block 24. Typically, cylinder liners 20 are manufactured separately from the engine block 24 and are subsequently installed in the engine block 24 before the pistons 36 are installed. Notwithstanding, this exemplary manufacturing and assembly process may be modified and is not intended to limit the subject disclosure.

Referring generally to FIGS. 2-6, the cylinder liner 20 includes a liner wall 42 that extends annularly about a piston bore 44 and axially between a first end 46 and a second end 48. The first end 46 of the liner wall 42 is disposed adjacent the deck surface 40 of the engine block 24 and the second end 48 of the liner wall 42 is disposed adjacent the crankcase 30 of the engine block 24. The liner wall 42 has an inner face 50 adjacent the piston bore 44 and an outer face 52 adjacent the cylinder bore 26 of the engine block 24. Accordingly, the outer face 52 of the liner wall 42 is oppositely arranged with respect to the inner face 50 of the liner wall 42. The inner face 50 of the liner wall 42 presents a smooth cylindrical surface extending from the first end 46 of the liner wall 42 to the second end 48 of the liner wall 42. When the cylinder liner 20 is installed in a fully assembled internal combustion engine 22, the inner face 50 of the liner wall 42 contacts the piston 36. To minimize drag between the piston 36 and the cylinder liner 20 and/or improve thermal characteristics, the inner face 50 of the liner wall 42 may optionally receive a coating or treatment.

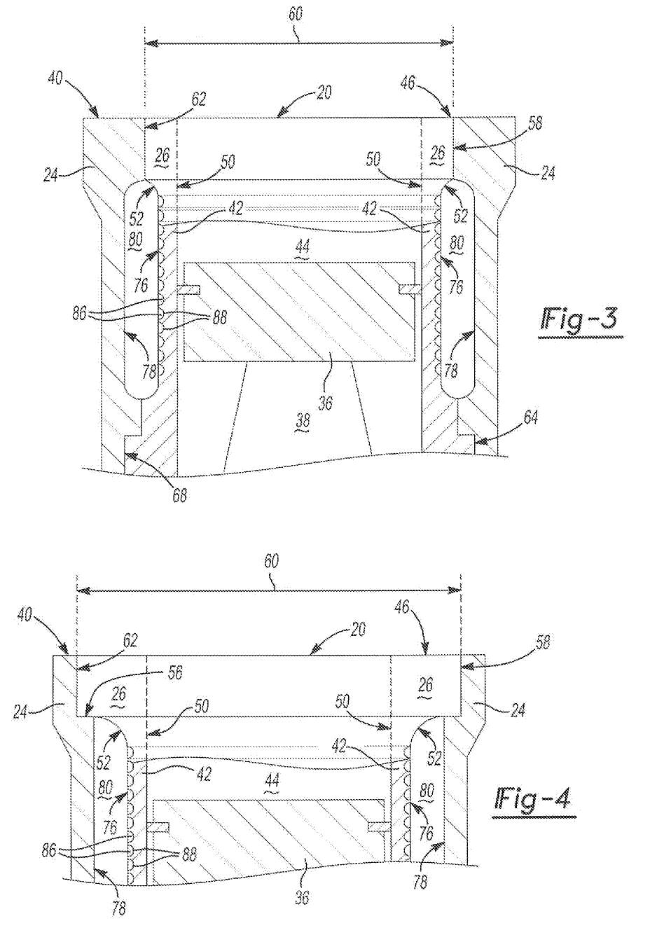

The liner wall 42 may or may not have a variable thickness. Several features may be disposed at various axial positions along the cylinder liner 20. As shown in FIGS. 2 and 5, a flange 54 may optionally be provided that projects radially outwardly from the first end 46 of the liner wall 42. The flange 54 may be configured to mate with a shoulder 56 formed in the cylinder bore 26 adjacent the deck surface 40. Thus, when the cylinder liner 20 is installed in the cylinder bore 26 the flange 54 abuts the shoulder 56 to axially locate the cylinder liner 20 with respect to the cylinder bore 26 and prevent over-insertion of the cylinder liner 20 beyond the flange 54. As shown in FIGS. 3, 4, and 6, the liner wall 42 may alternatively be free of the flange 54 and the cylinder bore 26 may or may not have the shoulder 56.

Where the liner wall 42 has a variable thickness, the outer face 52 of the liner wall 42 may also include a first abutment surface 58. The first abutment surface 58 may be axially positioned adjacent the first end 46 of the liner wall 42. Where the liner wall 42 includes the flange 54, the first abutment surface 58 is positioned immediately adjacent the flange 54 as shown in FIGS. 2 and 5. The first abutment surface 58 abuts the cylinder bore 26 of the engine block 24 when the cylinder liner 20 is installed in the cylinder bore 26. The first abutment surface 58 generally defines a first diameter 60. Because the first abutment surface 58 abuts the cylinder bore 26, the first diameter 60 of the first abutment surface 58 may be sized to create an interference fit between a corresponding portion 62 of the cylinder bore 26 and the first abutment surface 58. Such an interference fit may require the cylinder liner 20 to be pressed into the cylinder bore 26 of the engine block 24 during installed and functions to secure the cylinder liner 20 within the cylinder bore 26 so that the cylinder liner 20 does not move radially within the cylinder bore 26 or axially relative to the engine block 24.

As shown in FIG. 4, the first abutment surface 58 of the liner wall 42 may alternatively extend radially outwardly to mate with the shoulder 56 formed in the cylinder bore 26. In this configuration, the first abutment surface 58 replaces the flange 54. With reference to FIG. 6, the outer face 52 of the liner wall 42 may further include a second abutment surface 64 at the second end 48 of the liner wall 42. The second abutment surface 64 may also abut the cylinder bore 26 of the engine block 24 when the cylinder liner 20 is installed in the cylinder bore 26. The second abutment surface 64 has a second diameter 66, which may be equal to the first diameter 60 of the first abutment surface 58. Accordingly, the second diameter 66 of the second abutment surface 64 may be sized to create an interference fit between a corresponding portion 68 of the cylinder bore 26 and the second abutment surface 64.

Still referring to FIG. 6, the outer face 52 of the liner wall 42 may optionally include at least one sealing groove 70 disposed along the second abutment surface 64 that extends annularly along the liner wall 42. The at least one groove also extends radially inwardly from the second abutment surface 64 and is open to the cylinder bore 26 of the engine block 24. The outer face 52 of the liner wall 42 abuts the cylinder bore 26 at the second abutment surface 64 to create a seal 72. Furthermore, the at least one sealing groove 70 may include multiple sealing grooves 70 that are axially spaced from one another and disposed along the second abutment surface 64.

Referring to FIGS. 2-6 generally, the outer face 52 of the liner wall 42 includes a water jacket surface 76 that is co-extensive with at least part of the outer face 52. When the cylinder liner 20 is installed in the cylinder bore 26, the water jacket surface 76 is axially aligned with a water jacket channel 78 formed about the cylinder bore 26 of the engine block 24. The water jacket channel 78 is defined by the engine block 24 and is open to the water jacket surface 76 of the liner wall 42. Together, the water jacket surface 76 of the liner wall 42 and the water jacket channel 78 of the engine block 24 define a water jacket passageway 80 disposed between the water jacket surface 76 and the engine block 24. Although, a variety of different shapes for the water jacket passageway 80 are possible, by way of example and without limitation, the water jacket passageway 80 may generally extend annularly about the water jacket surface 76 of the liner wall 42. During operation of the internal combustion engine 22, coolant water is pumped through the water jacket passageway 80 to cool the cylinder liner 20 and the engine block 24. Heat created by the combustion process is transferred to the cylinder liner 20, which is then transferred to the coolant water. As the coolant water in the water jacket passageway 80 is replenished, heat is removed from the cylinder liner 20 and engine block 24 with the flow of coolant water. It should be appreciated that the terms “water jacket” and “coolant water” as used herein are terms of art. Notwithstanding their inclusion, such terms are not intended to be limiting. The coolant water disposed within the water jacket passageway 80 need not be pure water, but rather the coolant water could be any fluid including without limitation pure water and aqueous solutions.

The water jacket surface 76 spans an axial length 82. Where the liner wall 42 includes the first abutment surface 58, but no second abutment surface 64, the water jacket surface 76 may be disposed axially between the first abutment surface 58 and the second end 48 of the liner wall 42. In this configuration, the axial length 82 of the water jacket may be measured between the first abutment surface 58 and the second end 48 of the liner wall 42. Additionally, the water jacket surface 76 may be disposed radially inwardly of the first abutment surface 58 such that the water jacket surface 76 has a nominal diameter 84 that is smaller than the first diameter 60 of the first abutment surface 58. Where the liner wall 42 includes both the first abutment surface 58 and the second abutment surface 64, the water jacket surface 76 may be disposed axially between the first abutment surface 58 and the second abutment surface 64. The axial length 82 of the water jacket surface 76 may thus be measure between the first abutment surface 58 and the second abutment surface 64. Further, in this configuration the water jacket surface 76 may be disposed radially inwardly of both the first abutment surface 58 and the second abutment surface 64 such that the nominal diameter 84 of the water jacket surface 76 is smaller than the first diameter 60 of the first abutment surface 58 and the second diameter 66 of the second abutment surface 64.

As shown in FIGS. 2-12, a plurality of indentations 86 are disposed along the water jacket surface 76 of the outer face 52 of the liner wall 42. The plurality of indentations 86 extend radially inwardly from the water jacket surface 76 toward the inner face 50 to define corresponding areas 88 in the liner wall 42 of compacted material. The plurality of indentations 86 are formed by a deformation process where no material is removed from the liner wall 42 adjacent the water jacket surface 76. As such, it should be appreciated that the compacted material in the liner wall 42 will have a density that is greater than the density of the material in the liner wall 42 that is outside the corresponding areas 88 of compacted material. By way of example and without limitation, the compact material in the liner wall 42 may have a density of 2,835 kilograms per cubic meter (kg/m³), whereas the material in the liner wall 42 outside the corresponding areas 88 of compacted material may have a density of 2,700 kilograms per cubic meter (kg/m³). Advantageously, the plurality of indentations 86 can increase hoop strength of the liner wall 42 while increasing a surface area of the water jacket surface 76. The increased surface area of the water jacket surface 76 improves heat transfer away from the liner wall 42 because more of the coolant water within the water jacket passageway 80 comes into contact with the cylinder liner 20 for any given axial length 82 of the water jacket surface 76. This is advantageous because increased heat transfer away from the cylinder liner 20 allows engineers to configure the internal combustion engine 22 to generate more heat without reaching component reliability thresholds. This results in a more powerful and efficient internal combustion engine 22.

Although the thickness of the liner wall 42 is reduced at each indentation 86 of the plurality of indentations 86, the strength of the liner wall 42 can be improved rather than reduced because the deformation process forming the plurality of indentations 86 compacts the liner wall 42 in corresponding areas 88 adjacent to (radially inward of) each indentation 86. The resulting compacted material of the liner wall 42 can result in increased hoop strength of the cylinder liner 20. This characteristic is particularly beneficial because the cylinder liner 20 is subject to severe pressures associated with the combustion process. These pressures result in forces acting radially outwardly on the liner wall 42, which could rupture in unsupported areas 88 such as along the water jacket passageway 80. The hoop strength of the liner wall 42 resists such forces so a thinner, lighter, and less expensive liner can be used without risking cylinder liner failure after the plurality of indentations 86 are applied to the water jacket surface 76 of the cylinder liner 20 as disclosed.

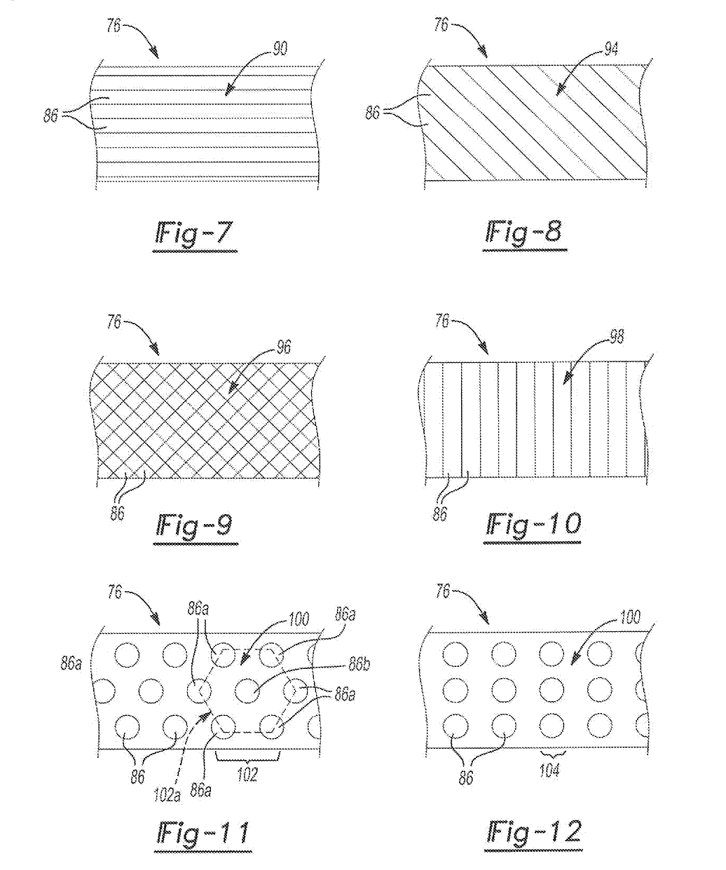

The plurality of indentations 86 may be arranged in a pattern that spans the axial length 82 of the water jacket surface 76. In other words, the plurality of indentations 86 may be spaced along the entire water jacket surface 76. Without departing from the scope of the present disclosure, the plurality of indentations 86 may be formed in a variety of different shapes and the pattern in which the plurality of indentations 86 are arranged may vary. Several examples are discussed herein and illustrated in FIGS. 5-12. It should be appreciated that these variations are merely exemplary and are not intended to be limiting. In one configuration, the plurality of indentations 86 may be multiple grooves 74 that are spaced along the water jacket surface 76. As shown in FIGS. 5 and 7, each of the multiple grooves 74 extends annularly along the water jacket surface 76 such that the pattern formed by the plurality of indentations 86 comprises an arrangement of stacked rings 90. Where the cylinder liner 20 is vertically oriented as shown in FIG. 5, the multiple grooves 74 extend horizontally. Alternatively, the plurality of indentations 86 may form a spiral groove 92 as shown in FIG. 6. The spiral groove 92 may generally extend helically along the water jacket surface 76 and wind around a central longitudinal axis L of the cylinder liner 20 while extending axially along the water jacket surface 76. It should also be appreciated that the spiral groove 92 may be interrupted or may be continuous. Where the spiral groove 92 is continuous, the plurality of indentations 86 are formed by each turn or thread of the spiral groove 92 although each turn of thread may be interconnected as part of one continuous spiral groove 92. In another variation shown in FIG. 8, each of the multiple grooves 74 extends diagonally along the water jacket surface 76 such that the pattern formed by the plurality of indentations 86 comprises an arrangement of slanted rings 94. Where the cylinder liner 20 is vertically oriented as shown in FIG. 5, the multiple grooves 74 shown in FIG. 9 extend in a direction that includes both a horizontal component and a vertical component.

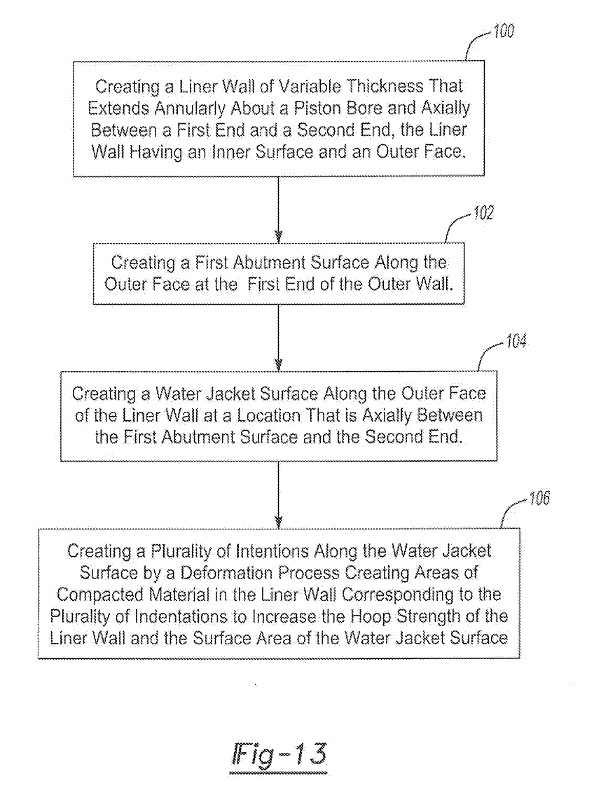

With reference to FIG. 9, the plurality of indentations 86 may be configured as a diamond pattern of knurling 96 that extends across the water jacket surface 76. As shown in FIG. 10, where the plurality of indentations 86 are multiple grooves 74, each of the multiple grooves 74 may extend axially along the water jacket surface 76. According to this configuration, the pattern formed by the plurality of indentations 86 comprises an arrangement of linear ridges 98. Where the cylinder liner 20 is vertically oriented as shown in FIG. 5, the multiple grooves 74 of the configuration shown in FIG. 10 extend vertically. In yet another arrangement, the plurality of indentations 86 may be dimples 100 that are spaced along the water jacket surface 76. As shown in FIG. 11, the dimples 100 may be arranged such that the pattern formed by the plurality of indentations 86 comprises a hexagonal lattice 102 of dimples 100, where each row of indentations 86 is axially offset from adjacent rows. In accordance with this dimpling pattern, an imaginary hexagon 102a can be drawn over a grouping of indentations 86a where one indentation 86b is centered within the imaginary hexagon 102a. Alternatively, FIG. 12 illustrates dimples 100 that are axially aligned with one another such that the pattern formed by the plurality of indentations 86 comprises axially extending rows 104 of dimples 100. In accordance with these arrangements, the plurality of indentations 86 may advantageous promote turbulence in the coolant water flowing through the water jacket passageway 80 to further enhance heat transfer away from the cylinder liner 20.

The subject disclosure also contemplates a method for manufacturing the disclosed cylinder liner 20. The method comprises several steps, which are set forth in the flow diagram illustrated in FIG. 13. Step 100 includes creating a liner wall 42 of variable thickness that extends annularly about a piston bore 44 and axially between a first end 46 and a second end 48. Thus, the liner wall 42 created by step 100 may be roughly cylindrical and has an inner face 50 adjacent the piston bore 44 and an outer face 52 that is opposite the inner face 50. Step 102 includes creating a first abutment surface 58 along the outer face 52 at the first end 46 of the liner wall 42. In accordance with step 102, the first abutment surface 58 is created such that it has a first diameter 60. Step 104 includes creating a water jacket surface 76 along the outer face 52 of the liner wall 42 at a location that is axially between the first abutment surface 58 and the second end 48. In accordance with step 104, the water jacket surface 76 may be created such that it is radially inset with respect to the first abutment surface 58. In other words, the water jacket surface 76 created by step 104 may have a nominal diameter 84 that is smaller than the first diameter 60 of the first abutment surface 58. The method further includes step 106 of creating a plurality of indentations 86 along the water jacket surface 76 by a deformation process. This deformation process is performed without removing material from the liner wall. By way of example and without limitation, the deformation process comprises knurling, dimpling, and/or rolling. In accordance with step 106, the deformation process creates areas of compacted material in the liner wall 42 corresponding to the plurality of indentations 86. This increases the hoop strength of the liner wall 42 and the surface area 88 of the water jacket surface 76 at the same time. As explained above, by increasing the surface area 88 of the water jacket surface 76 by applying a plurality of indentations 86 to the water jacket surface 76 of the cylinder liner 20, the subject method creates a cylinder liner 20 with improved strength and heat transfer characteristics. It should also be appreciated that step 102 of the method may further include creating a second abutment surface 64 along the outer face 52 at the second end 48 of the liner wall 42, where the second abutment surface 64 has a second diameter 66 that is equal to the first diameter 60 of the first abutment surface 58 and where the water jacket surface 76 is arranged axially between the first and second abutment surfaces 58, 64. It should be appreciated that the steps of creating the liner wall 42, creating the first abutment surface 58, creating the water jacket surface 76, and creating the second abutment surface 64 may be completed in discrete steps or may be combined. Further, the term “creating” as used herein means making by a manufacturing process, which may include, without limitation, extruding, machining, molding, casting, turning, rolling, and/or stamping.

Many modifications and variations of the present invention are possible in light of the above teachings and may be practiced otherwise than as specifically described while within the scope of the appended claims. These antecedent recitations should be interpreted to cover any combination in which the inventive novelty exercises its utility. With respect to the methods set forth herein, the order of the steps may depart from the order in which they appear without departing from the scope of the present disclosure and the appended method claims. Additionally, various steps of the method may be performed sequentially or simultaneously in time.

What is claimed is:

1. A cylinder liner comprising:
a liner wall that extends annularly about a piston bore;
said liner wall having an inner face adjacent said piston bore and an outer face that is oppositely arranged with respect to said inner face;
said outer face of said liner wall including a water jacket surface that is co-extensive with at least part of said outer face; and
a plurality of indentations disposed along said water jacket surface that extend radially inwardly from said water jacket surface to define corresponding areas in said liner wall of compacted material, said plurality of indentations increasing hoop strength of said liner wall and increasing a surface area of said water jacket surface to improve heat transfer away from said liner wall.

2. A cylinder liner as set forth in claim 1 wherein said plurality of indentations are formed by a deformation process where no material is removed from said liner wall adjacent said water jacket surface.

3. A cylinder liner as set forth in claim 1 wherein said plurality of indentations are arranged in a pattern that spans an axial length of said water jacket surface.

4. A cylinder liner as set forth in claim 1 wherein said plurality of indentations form a diamond pattern of knurling across said water jacket surface.

5. A cylinder liner as set forth in claim 1 wherein said plurality of indentations form a spiral groove that extends helically along said water jacket surface.

6. A cylinder liner as set forth in claim 1 wherein said plurality of indentations are multiple grooves spaced along said water jacket surface.

7. A cylinder liner as set forth in claim 6 wherein each of said multiple grooves extends annularly along said water jacket surface such that said plurality of indentations comprises an arrangement of stacked rings formed by said multiple grooves.

8. A cylinder liner as set forth in claim 6 wherein each of said multiple grooves extends axially along said water jacket surface such that said plurality of indentations comprises an arrangement of linear ridges formed by said multiple grooves.

9. A cylinder liner as set forth in claim 6 wherein each of said multiple grooves extends diagonally along said water jacket surface such that said plurality of indentations comprises an arrangement of slanted rings formed by said multiple grooves.

10. A cylinder liner as set forth in claim 1 wherein said plurality of indentations are dimples spaced along said water jacket surface.

11. A cylinder liner as set forth in claim 10 wherein said dimples are axially aligned with one another such that said plurality of indentations comprises axially extending rows of dimples.

12. A cylinder liner as set forth in claim 10 wherein said dimples are arranged such that said plurality of indentations comprises a hexagonal lattice of dimples.

13. A cylinder liner as set forth in claim 1 wherein said water jacket surface is axially aligned with a water jacket channel disposed about a cylinder bore of an engine block to define a water jacket passageway between said water jacket surface of said liner wall and the water jacket channel of the engine block.

14. A cylinder liner for insertion into a cylinder bore of an engine block, said cylinder liner comprising:
a liner wall of variable thickness that extends annularly about a piston bore and axially between a first end and a second end;
said liner wall having an inner face adjacent said piston bore that presents a smooth cylindrical surface extending from said first end of said liner wall to said second end of said liner wall;
said liner wall having an outer face configured to be adjacent the cylinder bore of the engine block that is oppositely arranged with respect to said inner face;
said outer face of said liner wall including a first abutment surface axially adjacent said first end, configured to abut the cylinder bore of the engine block, and defining a first diameter;
said outer face of said liner wall including a water jacket surface that is disposed axially between said first abutment surface and said second end and that is disposed radially inwardly of said first abutment surface to define a nominal diameter that is smaller than said first diameter of said first abutment surface; and
a plurality of indentations disposed along said water jacket surface of said outer face of said liner wall that extend radially inwardly from said water jacket surface to define corresponding areas in said liner wall of compacted material, said plurality of indentations increasing hoop strength of said liner wall and increasing a surface area of said water jacket surface to improve heat transfer away from said liner wall.

15. A cylinder liner as set forth in claim 14 wherein said plurality of indentations are formed by a deformation process where no material is removed from said liner wall adjacent said water jacket surface.

16. A cylinder liner as set forth in claim 14 wherein said outer face of said liner wall includes a second abutment surface at said second end that abuts the cylinder bore of the engine block and that defines a second diameter that is equal to said first diameter.

17. A cylinder liner as set forth in claim 16 wherein said water jacket surface extends axially between said first abutment surface and said second abutment surface, said water jacket surface having an axial length that extends axially between said first abutment surface and said second abutment surface.

18. A cylinder liner as set forth in claim 17 wherein said plurality of indentations are arranged in a pattern that spans the axial length of said water jacket surface.

19. A cylinder liner as set forth in claim 16 wherein said outer face of said liner wall includes at least one sealing groove disposed along said second abutment surface that extends annularly along said liner wall and radially inwardly from said second abutment surface, said at least one sealing groove configured to be open to the cylinder bore of the engine block to create a seal between said outer face of said liner wall and the cylinder bore at said second abutment surface.

20. A cylinder liner as set forth in claim 19 wherein said at least one sealing groove includes multiple sealing grooves that are axially spaced from one another and disposed along said second abutment surface.

21. A cylinder liner as set forth in claim 14 wherein said plurality of indentations form knurling across said water jacket surface.

22. A cylinder liner as set forth in claim 14 wherein said plurality of indentations form a spiral groove that extends helically along said water jacket surface.

23. A cylinder liner as set forth in claim 14 wherein said plurality of indentations are multiple grooves spaced along said water jacket surface.

24. A cylinder liner as set forth in claim 14 wherein said first end of said liner wall is configured to be disposed adjacent a deck surface of the engine block and said second end of said liner wall is configured to be disposed adjacent a crankcase of the engine block.

25. A cylinder liner as set forth in claim 24 wherein said liner wall includes a flange at said first end that projects radially outwardly and is configured to mate with a shoulder disposed in the cylinder bore adjacent the deck surface to axially locate said cylinder liner with respect to the cylinder bore and to prevent over-insertion of said cylinder liner beyond said flange.

26. A cylinder liner as set forth in claim 14 wherein said water jacket surface is configured to be axially aligned with a water jacket channel disposed about the cylinder bore of the engine block to define a water jacket passageway between said water jacket surface of said liner wall and the water jacket channel of the engine block.

27. A method of manufacturing a cylinder liner comprising the steps of:
creating a liner wall that extends annularly about a piston bore and axially between a first end and a second end, the liner wall defining an inner face adjacent the piston bore and an outer face that is opposite the inner face;
creating a water jacket surface along the outer face of the liner wall at a location that is axially between the first end and the second end; and
creating a plurality of indentations along the water jacket surface by a deformation process, the deformation process creating areas of compacted material in the liner wall corresponding to the plurality of indentations to increase hoop strength of the liner wall while increasing a surface area of the water jacket surface to improve heat transfer away from the liner wall.

28. A method as set forth in claim 27 further comprising the step of:
creating a first abutment surface along the outer face of the liner wall at the first end of the liner wall, the first abutment surface having a first diameter.

29. A method as set forth in claim 28 wherein said step of creating the water jacket surface includes creating the water jacket surface at a location that is radially inset with respect to the first abutment surface such that the water jacket surface has a nominal diameter that is smaller than the first diameter of the first abutment surface.

30. A method as set forth in claim 27 wherein the deformation process is performed without removing material from the liner wall.
